(19) United States
(12) Patent Application Publication
(10) Pub. No.: US 2022/0279836 A1
(43) Pub. Date: Sep. 8, 2022

(54) METHOD FOR THE MANUFACTURE OF SUSCEPTOR SHEET MATERIAL COMPRISING AN AEROSOL-FORMING GEL AND DOSING SYSTEM

(71) Applicant: PHILIP MORRIS PRODUCTS S.A., Neuchatel (CH)

(72) Inventors: Massimiliano Bertoldo, Castel Maggiore (IT); Gennaro Campitelli, Neuchatel (CH); Fabio Cantieri, Bologna (IT); Gianpaolo D'Ambra, Castel Maggiore (IT)

(21) Appl. No.: 17/630,200

(22) PCT Filed: Jul. 27, 2020
(86) PCT No.: PCT/EP2020/071133

§ 371 Date: Jan. 26, 2022

(30) Foreign Application Priority Data
Jul. 29, 2019 (EP) 19188737.1

(51) Int. Cl. A24C 5/01; A24D 1/20; A24B 15/167; H05B 6/10

(52) U.S. Cl. CPC A24C 5/01; A24D 1/20; A24B 15/167; H05B 6/105

(57) ABSTRACT

The method for the manufacture of a susceptor sheet material comprising an aerosol-forming gel comprises the steps of providing a susceptor sheet material comprising at least one depression on both sides of the susceptor sheet material; and applying aerosol-forming gel to the at least one depression on both sides of the susceptor sheet material. Also a dosing device for the application of an aerosol-forming gel is described.

The invention relates to a method for the application of an aerosol-forming gel to a susceptor sheet material and a dosing system for the application of an aerosol-forming gel to a susceptor sheet material.

Methods are known to coat a susceptor material with an aerosol-forming coating. This may be done to provide aerosol delivery from the coating in direct contact with the heated susceptor. It is also known to provide susceptor material with different shapes in a tobacco plug of an inductively heatable aerosol-forming article. This is done, for example, to improve or vary an air or aerosol transport through the tobacco plug.

It is desirable to provide aerosol generation in an aerosol-generating article used in electronic aerosol-generating devices that allows high precision in aerosol delivery.

According to the invention, there is provided a method for the manufacture of a susceptor sheet material comprising an aerosol-forming gel. The method comprises providing a susceptor sheet material comprising at least one depression and applying an aerosol-forming gel to at least the depression in the susceptor sheet material.

Preferably, the method comprises providing the susceptor sheet material with at least one depression on both sides of the susceptor sheet material, and applying aerosol-forming gel to the at least one depression on both sides of the susceptor sheet material.

Preferably, the susceptor sheet material is provided with a plurality of depressions on one side of the susceptor sheet material.

Preferably, the susceptor sheet material is provided with a plurality of depressions on both sides of the susceptor sheet material.

Preferably, aerosol-forming gel is applied to several depressions on one side of the susceptor sheet material or to several depressions on both sides of the susceptor sheet material. More preferably, aerosol-forming gel is applied to each depression on one side of the susceptor sheet material or aerosol-forming gel is applied to each depression on both sides of the susceptor sheet material.

The method may further comprise applying different aerosol-forming gels to different depressions of the susceptor sheet material. Different aerosol-forming gels may differ, for example, in at least one of flavour, nicotine content, alkaloid content, alkaloid type, content of aerosol-forming agent, type of aerosol-forming agent, or aerosolization temperature.

Preferably the method comprises applying the aerosol-forming gel via a through hole in at least one moving tooth of a gel dosing device.

The moving tooth of the gel dosing device may, for example be a tooth of a dosing wheel drum, a tooth of a dosing roller or a tooth of a dosing belt.

The method may comprise the step of applying the aerosol-forming gel via the through hole in at least one moving tooth of a dosing wheel drum comprising circumferentially arranged teeth. Additionally or alternatively, the method may comprise applying the aerosol-forming gel via the through hole in at least one moving tooth of a dosing belt, and transporting the susceptor sheet material with the dosing belt.

By the provision of a dosing belt transport and gel application may be combined in one device.

Preferably, the dosing belt comprises a series of teeth substantially corresponding to the form of the susceptor sheet material. The teeth, for example one, several or each tooth, comprises a through hole in communication with or to be brought into communication with a gel reservoir. Preferably, the method comprises the step of bringing a tooth of the dosing belt into communication with the reservoir when the tooth passes the reservoir upon movement of the dosing belt. Thus, each tooth comprising a through hole may be brought into communication with the same reservoir upon passing the reservoir.

Preferably, the method comprises applying the aerosol-forming gel over a width of the susceptor sheet material through a plurality of through holes arranged over a width of a tooth.

Preferably, the method comprises continuously applying aerosol-forming gel along a length of the susceptor sheet material.

Preferably, a tooth comprises a plurality of through holes arranged along a width of the tooth. Each through hole substantially ends at a tip of the tooth. Where in some embodiments the tooth is a tooth of a wheel drum or of a conveyor belt, the plurality of through holes is arranged along the width of the drum or belt. This may be favourable as aerosol-forming gel may be applied to individual depressions arranged over a width of the susceptor sheet material. Aerosol-forming gel may also be applied along the width of a trough, if the trough extends over the width of the susceptor sheet material. Where in some embodiments the tooth is a tooth of a dosing roller, one or a plurality of through holes is arranged along the circumference of the tooth. This may be favourable as aerosol-forming gel may continuously be applied to elongate depressions, such as for example longitudinal grooves, arranged along a length of the susceptor sheet material. A distribution of aerosol-forming gel along the width or along the length of the susceptor sheet material may be continuous along the width or along the length. A distribution of aerosol-forming gel along the width or along the length of the susceptor sheet material may be equal along the width or length with an equal amount of aerosol-forming gel along the width or length.

A distribution of aerosol-forming gel along the width or length of the susceptor sheet material may be non-continuous. A distribution of aerosol-forming gel along the width or length of the susceptor sheet material may be non-equal along the width or length. For example, individual drops of aerosol-forming gel may be arranged over the width or along the length of the susceptor sheet. For example, more aerosol-forming gel may be arranged in a central longitudinal region of the susceptor sheet than in lateral edge regions of the susceptor sheet. The aerosol-forming gel may form an even layer in and along a depression.

A number or size of through holes in a tooth may be adapted to the characteristics of the aerosol-forming gel, in particular to the viscosity of the aerosol-forming gel.

The method may comprise applying the aerosol-forming gel via the through hole in at least one moving tooth of a dosing roller, wherein the moving tooth is arranged parallel to the direction of transport of the susceptor sheet material and rotates in the direction of transport of the susceptor sheet material. The moving tooth may be provided with a continuous through hole extending along the entire length of the tooth or along the entire circumference of the dosing roller, respectively, for continuous gel application. In these embodiments, the susceptor sheet material is provided with at least one longitudinally extending depression, for example in the form of a groove, arranged along the length of the susceptor material. A susceptor comprising at least one longitudinally arranged depression is easy to manufacture in a continuous forming process. A so formed susceptor material has an intrinsic rigidity as the bending of for example a susceptor band having a v-shaped or w-shaped cross section requires more power that the bending of a flat band. For example, any deformation or misalignment of the susceptor in an article will be less affected when cutting a continuous article into individual segments. Susceptors with w-shaped cross sections may be provided with different kinds of aerosol-forming gel on the two sides of the susceptor with no risk of mixing of the different kinds of gel.

According to the invention, there is provided a dosing system for the application of an aerosol-forming gel to a susceptor sheet material. The system comprises a susceptor sheet material comprising at least one depression. The system also comprises a gel dosing device adapted to apply aerosol-forming gel to the at least one depression of the susceptor sheet material.

By using a susceptor material comprising at least one depression the amount of susceptor material may be increased compared to a flat susceptor material. The amount of susceptor material per length of an article the susceptor is arranged in may be increased. In particular, the surface area of the susceptor is increased. This is favourable as heat is preferably and primarily generated in the susceptor material by eddy currents. These are mainly skin currents generated in the susceptor sheet material when the susceptor sheet material is inductively heated. Having a larger surface area available per length of a susceptor material, more heat may be generated over said length.

The gel dosing device of the dosing system may comprise at least one tooth substantially corresponding to the form of the at least one depression in the susceptor sheet material. The at least one tooth of the gel dosing device may comprise a through hole in fluid communication with a gel reservoir comprising aerosol-forming gel. In this embodiment, the aerosol-forming gel is delivered from the gel reservoir and through the through hole of the tooth and is applied to the susceptor sheet material. In particular the gel is applied into the at least one depression in the susceptor material. Preferably, the tooth of the dosing device is inserted into the depression of the susceptor material for gel application. When the tooth passes the depression, a portion of aerosol-forming gel is deposited in the depression of the susceptor material.

The through hole is in fluid communication with the gel reservoir when applying the aerosol-forming gel to the susceptor. The through hole does not have to be constantly in fluid communication with the reservoir. The through hole may be brought into communication with the reservoir at or shortly before applying the aerosol-forming gel. A closure may be provided for closing a fluid communication between through hole and gel reservoir.

Preferably, the gel dosing device comprises several teeth, wherein at least one tooth of the several teeth comprises a through hole for applying aerosol-forming gel to the susceptor material. More preferably, several teeth comprise a through hole, preferably for applying aerosol-forming gel to several depressions in the susceptor material. For example all teeth of the dosing device may comprise a through hole. Preferably, all teeth comprise a through hole for applying aerosol-forming gel to at least several depressions in the susceptor material. More preferably, all teeth comprise a through hole for applying aerosol-forming gel to all depressions in the susceptor material.

A variation in the amount of teeth being provided with through holes and being in communication with a gel reservoir provides the advantage of being capable of adjusting the amount of aerosol-forming gel applied over a length of the susceptor material.

The through holes of the gel dosing device may be in communication with one and the same reservoir. The through holes of the gel dosing device may be in communication with different reservoirs. Different reservoirs may comprise the same aerosol-forming gel. Different reservoirs may comprise or different aerosol-forming gels.

Several dosing devices may be arranged in succession. Preferably, each of the several dosing devices is in fluid communication with a gel reservoir comprising a different aerosol-forming gel. A susceptor sheet material may then pass each of the several dosing devices. With each dosing device one, several or all depressions are filled with an aerosol-forming gel. Non-filled depressions as well as already filled depressions are (further) filled when the susceptor passes a subsequently arranged gel dosing device. By this, different fillings of a depression may be realised. Alternatively or in addition, multiple-filling of a depression may be realized.

The aerosol-forming gel or aerosol-forming gels may be pushed via a pump to the tooth. In some embodiments, the gel reservoir may be pressurized. Also combinations of pressurized gel and pump may be realized to deliver aerosol-forming gel to a tooth of a dosing device.

The dosing system, for example a reservoir or a dosing device, may comprise heating means for heating the aerosol-forming gel. The heating means may for example be provided to liquefy the gel.

In embodiments where a susceptor sheet material comprises at least one depression on both sides of the susceptor sheet material, then the gel dosing device is adapted to apply aerosol-forming gel to the at least one depression on both sides of the susceptor sheet material.

The gel dosing device may comprise a dosing wheel drum comprising circumferentially arranged teeth substantially corresponding to the form of the susceptor material, in particular to the form of depressions in the susceptor material. In some embodiments, at least one tooth of the dosing wheel drum comprises the through hole in fluid communication with the gel reservoir comprising aerosol-forming gel. Preferably, the circumferentially arranged teeth of the dosing wheel drums are arranged parallel to the rotation axis of the dosing wheel drum and perpendicular to a transport direction or length of the susceptor sheet material.

Preferably the gel dosing device comprises a pair of engaging dosing wheel drums. Both wheel drums comprise circumferentially arranged teeth, the teeth engaging each other upon rotation of the wheel drums. At least one tooth of one dosing wheel drum of the pair of dosing wheel drums comprises a through hole in communication with a gel reservoir for aerosol-forming gel. Preferably, with a pair of engaging dosing wheel drums, at least one tooth of both dosing wheel drums of the pair of dosing wheel drums comprises a through hole in fluid communication with a gel reservoir. The two wheel drums of the pair of dosing wheel drums may be in fluid communication with the same or with different gel reservoirs. With two wheel drums, a susceptor is guided in between the two drums, where gel is applied to the susceptor.

The gel dosing device may comprise a dosing belt for transporting the susceptor sheet material. Therein, the tooth comprising the through hole is a tooth of the dosing belt.

Preferably, the dosing belt is a toothed conveyor belt, more preferably a closed-loop endless belt.

The gel dosing device may comprise a dosing roller comprising at least one circumferentially arranged tooth substantially corresponding to the form of at least one longitudinally extending depression in the susceptor material and extending in rotation direction of the dosing roller. In some embodiments, at least one tooth of the dosing roller comprises the through hole in fluid communication with the gel reservoir comprising aerosol-forming gel.

Preferably the gel dosing device comprises a pair of engaging dosing rollers. Both dosing rollers comprise at least one circumferentially arranged tooth, the teeth engaging each other upon rotation of the dosing roller in transport direction of a susceptor passing the two dosing rollers. At least one tooth of one dosing roller of the pair of dosing rollers comprises a through hole in communication with a gel reservoir for aerosol-forming gel. Preferably, with a pair of engaging dosing rollers, at least one tooth of both dosing rollers of the pair of dosing rollers comprises a through hole in fluid communication with a gel reservoir. The two dosing rollers of the pair of dosing rollers may be in fluid communication with the same or with different gel reservoirs. With two dosing rollers, a susceptor is guided in between the two rollers, where gel is applied to the susceptor. In embodiments with a pair of dosing rollers, preferably one dosing roller comprises one single tooth comprising a through hole in communication with a gel reservoir for aerosol-forming gel and the other engaging dosing roller comprises two teeth preferably each comprising a through hole in communication with a gel reservoir for aerosol-forming gel. The through holes may be continuous through holes extending along the entire circumference of a dosing roller for continuous gel application.

Preferably, a tip of a tooth comprising the through hole and the bottom of a depression of susceptor sheet material are at least partially distanced from each other when the tooth is inserted in the depression for aerosol-forming gel application. Preferably, the distance is selected to leave space for aerosol-forming gel to be applied into the depression of the susceptor sheet material.

This may be realized, for example, by the tooth comprising the through hole and having a flat tip. A depression comprises walls narrowing versus the bottom of the depression. Thus, if a tooth is entirely inserted into the depression of the susceptor material, there is a distance between the bottom of the depression and the flat tip of the tooth. This is advantageous as a gap is formed by this distance.

Alternatively or in addition, a tooth may not or not entirely be inserted into a depression of the susceptor material, such that a distance between tooth and susceptor material leaves space for the aerosol-forming gel.

Preferably, aerosol-forming gel is applied only into depressions of the susceptor material. Thus, the portion of the susceptor sheet material not comprising depressions, for example crests of a susceptor sheet material in wave form, are free of aerosol-forming gel.

Providing aerosol-forming gel only into depressions has the advantage of good localization of the aerosol-forming gel. A depression provides boundaries for the aerosol-forming gel, not only upon application of the aerosol-forming gel but also after application in the final susceptor sheet material comprising aerosol-forming gel. The gel is inhibited to further flow to other parts of the susceptor material upon application of the gel or when heated. This is an improvement over flat susceptor sheets. It is also advantageous in view of an amount of aerosol-forming gel heated by the susceptor material, as the size of a contact surface between susceptor material and aerosol-forming gel is well defined. The provision of aerosol-forming gel in depressions of the susceptor material also provides individual aerosol-forming gel portions along and across the susceptor material that may individually, serially or group-wise be heated. This may be used to provide various combinations and variations of aerosol generation.

The method may also comprise providing a conduit, for example a tube, with at least one gel inlet, guiding the susceptor sheet material inside and along the conduit, and injecting aerosol-forming gel via the at least one gel inlet into the conduit and to the susceptor sheet material guided inside and along the conduit.

A gel dosing device may accordingly comprise a conduit adapted to guide the susceptor sheet material inside and along the conduit. The conduit comprises at least one gel inlet for injection of aerosol-forming gel into the conduit and to the susceptor sheet material that is guided inside and along the conduit. Preferably, the at least one gel inlet is arranged to apply aerosol-forming gel to one side, for example an upper or a lower side, of the susceptor sheet material.

The conduit may comprise two or more gel inlets for injection of aerosol-forming gel. Preferably, two gel inlets are arranged opposite each other in the conduit, such that aerosol-forming gel may be applied to both sides of the susceptor sheet material.

Two or more gel inlets may also be arranged on a same side of the conduit. By this, aerosol-forming gel may be applied subsequently to the same side of the susceptor sheet material. The two or more gel inlets may be connected to the same or different gel reservoirs. Preferably, gel inlets on a same side are connected to different reservoirs preferably comprising different aerosol-forming gels. By this, a sequence of injections of different aerosol-forming gels may be realised. The different gels may be applied to a same depression or to different depressions.

A cross section of the conduit may substantially correspond to a width and height of a susceptor material. Ideally a cross section of the conduit is slightly larger than the width and height of the susceptor material. For example, the cross section of the conduit is between 5 percent to 10 percent larger than the width and height of the susceptor material. A cross section of the conduit may, for example, be rectangular. A cross section of the conduit may also have a different shape, for example elliptical or square.

The conduit may, for example, have a shape such that a susceptor material having passed the conduit is provided with aerosol-forming gel on an entire side of the susceptor material. Preferably, the susceptor material is provided with aerosol-forming gel on both sides of the susceptor material.

Preferably, a cross section of a conduit is decreasing when seen in a direction of transport of the susceptor material passing the conduit. Preferably, a conduit inlet has a larger cross section than the cross section of the susceptor sheet material to simplify insertion of the susceptor into the conduit. Preferably, a conduit outlet has a cross section substantially corresponding to the extensions of the cross section of the susceptor sheet material. Preferably, the conduit outlet has a cross section corresponding to the extension of the cross section of the sheet material plus 5 percent. The small difference in cross section may avoid or reduce friction. In some embodiments, the cross section of the conduit outlet is slightly larger than the extension of the susceptor sheet material in a height direction. A height direction is the direction of the depression extending from a plane or imaginary plane of the susceptor sheet material. By this, excess aerosol-forming gel may remain on the susceptor sheet material covering the susceptor sheet material.

The conduit may comprise an internal or external driving mechanism to support the passing of the susceptor through the conduit.

In some embodiments where the susceptor material passes a conduit and is provided with aerosol-forming gel by passing the conduit, not only depressions in the susceptor material are provided with aerosol-forming gel but also flat parts or for example crests of a susceptor in wave form are covered with aerosol-forming gel.

A dosing device in the form of a conduit is advantageous in that an entire surface of susceptor material may be coated with aerosol-forming gel and large amounts of aerosol-forming gel may be provided to the susceptor material. In addition, depending on the physical characteristics of the aerosol-forming gel applied to the susceptor material, the susceptor material may be embedded in aerosol-forming gel. An outer shape of an embedded susceptor material may be defined by the shape of the conduit, in particular an inner cross section of the conduit.

A susceptor sheet material having been provided with aerosol-forming gel may be stored, for example, coiled onto a bobbin. The susceptor sheet material comprising aerosol-forming gel may subsequently be unrolled from the bobbin and used in the manufacture of aerosol-generating articles, for example aerosol-generating rods.

A susceptor sheet material having been provided with aerosol-forming gel may directly, in particular inline, be used the manufacture of an aerosol-forming article.

A gel dosing device may, for example, be part of a rod forming device for forming aerosol-generating rods, for example tobacco rods. Preferably, the rods are used in the manufacture of inductively heatable aerosol-generating articles for electronic aerosol-generating devices such as hand-held inductively heating devices.

A gel dosing device comprising a conduit is particularly suitable for the online manufacturing of susceptor material comprising at least one depression and rod-forming of inductively heatable aerosol-generating rods. Preferably, the conduit is positioned within a funnel portion of a rod forming device for the manufacture of aerosol-generating articles. In such a rod-forming device, an aerosol-generating substrate, for example a tobacco sheet, is gathered in the funnel portion into a rod. Such rod-forming devices are known in the art.

The dosing device of the present invention may be positioned within or upstream of the funnel portion. A susceptor material comprising aerosol-forming gel exiting the gel dosing device, in particular a conduit of a gel dosing device, may directly be supplied to the rod forming device and inside the aerosol-generating substrate or other materials used in the rod forming process. The conduit or exit of the conduit acts as guiding as well as positioning means for the susceptor sheet material comprising aerosol-forming gel. In particular with a conduit, the susceptor material comprising the aerosol-forming gel may be positioned very precisely within the materials forming the rod, thus within the rod.

The dosing system may also be combined with a drying device. Preferably, the drying device removes liquid from the gel to make it solid on the susceptor. Such a drying device may be a drying device external or internal to the dosing device. An external drying device may, for example, be a fan or a heater provided downstream of a dosing device. An internal drying device may, for example, be a heater within the dosing device, for example incorporated into a conduit of a dosing device. Preferably, the drying device is realized by inductively heating the susceptor sheet material for drying the gel and liquid removal. Preferably, material release other than water or a liquefying material is prevented or limited to a minimum.

According to the invention there is also provided a rod forming device for the manufacture of aerosol-generating articles used in electronic aerosol-generating devices. The rod forming device comprises a dosing system according to the present invention and as described herein.

In the method according to the invention, the susceptor material may be pre-manufactured or may be manufactured inline before being provided with aerosol-forming gel. For example the susceptor material comprising at least one depression or a plurality of depressions may be supplied, for example from a bobbin, and guided to the dosing system as described herein. Alternatively, the method may comprise passing a susceptor material, for example a flat band or strip of susceptor material such as a metal band, through a susceptor forming device. By this, the previously flat susceptor sheet material is provided with at least one depression or with a plurality of depressions in the forming device.

The dosing system may accordingly comprise a susceptor forming device adapted to form the susceptor sheet material. The susceptor material is provided with at least one depression by passing the susceptor sheet material through the forming device. The susceptor forming device is arranged upstream of the gel dosing device. For example, a flat band of susceptor material is supplied to the susceptor forming device and is formed into a susceptor material comprising at least one depression in the susceptor forming device. The so formed susceptor sheet material is then further transported to the gel dosing device, where aerosol-forming gel is applied to the susceptor material.

A susceptor forming device may, for example comprise or consist of engaging rollers in the form of toothed wheel drums or of forming rollers comprising at least one circumferentially arranged tooth, the tooth extending in rotation direction of the forming roller. The susceptor material being forced between the teeth of the wheel drums or between the teeth of the forming rollers is deformed and provided with depressions in the form of protrusions and indentations or crests and troughs according to the form of the teeth of the toothed wheel drums or of the forming rollers. A susceptor forming device may also comprise several pairs of engaging rollers, for example for a subsequent forming of the susceptor material. For example, the individual rollers may provide the susceptor sheet material with continuously deeper depressions.

A gel dosing device comprising engaging dosing wheel drums may be combined as a forming and dosing unit. The engaging teeth of the gel dosing wheel drums then also act as forming elements.

A gel dosing device comprising engaging forming rollers may be combined as a forming and dosing unit. The engaging teeth of the gel dosing rollers then also act as forming elements.

The method may further comprise the step of passing the susceptor material and a porous sheet material in parallel through a gel dosing device. In the gel dosing device, the aerosol-forming gel is applied to the combination of susceptor sheet material and porous sheet material.

The porous sheet material may, for example be cotton, viscose or a tow material, for example, a cellulose acetate tow.

Preferably, the susceptor material and porous sheet material are passed between two gel dosing elements, such as two gel dosing wheel drums, two gel dosing rollers or two dosing belts arranged parallel and opposite each other.

The porous sheet material may help to fix the aerosol-forming gel to the susceptor material. The porous sheet material may in general help to fix the position of the aerosol-forming gel along the porous material and susceptor combination due to the porosity of the porous sheet material.

The porous sheet material may have a wicking action for the aerosol-forming gel, in particular when the gel is applied at elevated temperatures and more in the form of a liquid.

According to the invention, there is also provided a susceptor sheet material comprising aerosol-forming gel. The susceptor sheet material comprises a plurality of depressions, wherein at least one depression of the plurality of depressions in the susceptor material is filled with the aerosol-forming gel. Preferably, several or all depressions of the plurality of depressions are filled with aerosol-forming gel. Preferably, the susceptor sheet material comprises a plurality of depressions on both sides of the susceptor sheet material. Preferably, at least one depression on both sides of the susceptor sheet material is filled with aerosol-forming gel.

In embodiments with a susceptor sheet material in a wave form, preferably only the troughs of the wave are filled with aerosol-forming gel. By this, only portions of walls of the troughs of the susceptor material (which are filled with aerosol-forming gel) do comprise aerosol-forming gel. Depending on a filling level of the troughs, the wall portions of the troughs not being in contact with aerosol-forming gel may be smaller or larger. Thus, preferably the crests of the waves, in particular the tips of the crests, of the susceptor material do not comprise aerosol-forming gel. Preferably, all troughs, most preferably, only the troughs, on one or on both sides of the susceptor material comprise aerosol-forming gel. Thus, preferably all crests on one side, more preferably all crests on both sides of the susceptor material do not comprise aerosol-forming gel.

In embodiments, where the susceptor sheet material is provided with at least one depression extending along the length of the susceptor sheet material, preferably aerosol-forming gel is provided continuously and in constant amount along the length of the at least one depression.

In embodiments, where the susceptor sheet material is provided with at least one depression extending along the length of the susceptor sheet material on both sides of the susceptor sheet material, preferably different kind of aerosol-forming gel is provided on the two sides of the susceptor sheet material. The different kind of gel on the two sides of the susceptor may be provided continuously and in constant amount along the length of the at least one depressions on each of the two sides of the susceptor.

Preferably, the susceptor sheet material comprising one or a plurality of depressions and comprising aerosol-forming gel has been manufactured with the dosing device according to the invention and as described herein.

As used herein, the term ‘susceptor’ refers to a material that is capable to convert electromagnetic energy into heat. When located in an alternating electromagnetic field, typically eddy currents are induced and hysteresis losses may occur in the susceptor causing heating of the susceptor. As the susceptor is located in thermal contact with the aerosol-forming gel, the aerosol-forming gel is heated by the susceptor, releasing fluid from the susceptor.

The susceptor may be formed from any material that can be inductively heated to a temperature sufficient to release material from the aerosol-forming gel. Preferred susceptors comprise a metal or carbon. A preferred susceptor may comprise or consist of a ferrous or ferromagnetic material, for example ferritic iron, a ferromagnetic alloy, such as ferromagnetic steel, stainless steel or aluminium. The susceptor preferably comprises more than 5 percent, preferably more than 20 percent, preferably more than 50 percent or 90 percent of ferromagnetic or paramagnetic materials. Preferred susceptors may be heated to a temperature between about 150 degree Celsius and about 300 degree Celsius. Preferably, the susceptors may be heated to a temperature between about 200 degree Celsius and about 270 degree Celsius, for example 235 degree Celsius.

Preferably, a susceptor sheet material as is a metallic elongate material.

Preferably, a susceptor sheet material is a stainless steel band. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example Iron, Cobalt, Nickel, or metalloids components such as for example Bor, Carbon, Silicium, Phosphor, Aluminium.

The susceptor sheet material has the form of a band. Preferably, the band has a basic rectangular shape having a width preferably between about 2 millimeter and about 8 millimeter, more preferably, between about 3 millimeter and about 5 millimeter, for example 4 millimeter and a thickness preferably between about 0.03 millimeter and about 1 millimeter, more preferably between about 0.05 millimeter and about 0.5 millimeter, for example between about 0.07 millimeter and about 0.2 millimeter. The width of the susceptor band is smaller than a width or diameter of a plug the susceptor is arranged in.

As a general rule, whenever the term ‘about’ is used in connection with a particular value throughout this application this is to be understood such that the value following the term ‘about’ does not have to be exactly the particular value due to technical considerations. However, the term ‘about’ used in connection with a particular value is always to be understood to include and also to explicitly disclose the particular value following the term ‘about’.

As used herein the term ‘depression’ in combination with the susceptor sheet material is understood to comprise a non-flat structure comprising deformations, in the form of indentations and protrusions, crests and troughs or similar forms. Therein, an indentation forms a protrusion on the opposite side of the susceptor sheet material and a crest forms a trough on the opposite side of the susceptor sheet material. The ‘depressions’ may be confined in the plane of the susceptor sheet material or may be open in the plane of the susceptor sheet material. For example, a depression may be open towards the side edges of a band of susceptor sheet material. A confined depression preferably has a circular or oval shape. An open depression preferably has the form of a groove extending in the susceptor sheet material, preferably, in longitudinal or transverse direction of the susceptor sheet material.

Preferably, the depressions form a series of depressions. The series may be a regular series. The series may be an irregular series. The depressions may be arranged in one or several rows along the susceptor sheet material. Preferably, the depressions in the susceptor sheet material are arranged regularly along the length of the susceptor material. The depressions may have pointed, rounded or flat shapes (v-shape, u-shape, trapezoid shape).

The susceptor sheet material may be an elongate susceptor material having a wave-shape. The susceptor sheet material may be a corrugated band, wherein the corrugations are preferably arranged perpendicular to the longitudinal axis of the band. The susceptor sheet material may be a corrugated band wherein one or several corrugations are arranged parallel to the longitudinal axis of the band. The corrugations may have pointed, rounded or trapezoid shapes. Thus, the corrugations may have a triangular shape with pointed tips and valleys. Or, the corrugations may have rounded tips and rounded valleys. Or, the corrugations may have crests and troughs with flat tips and flat bottoms.

Preferably, a susceptor sheet material has a zigzag shape or a sinusoidal shape along a longitudinal or transverse cross section. If the susceptor sheet material has a wave-shape, then preferably a distance between neighbouring crests or between neighbouring troughs of the susceptor material is constant. Preferably, a distance between a neighbouring crest and trough is constant. Preferably, the crests and troughs form a continuous periodic function along the length of the susceptor sheet material in wave form. A constant arrangement of crests and troughs allows the manufacture of a regular continuous susceptor sheet material. This is advantageous in that a final article, where the susceptor sheet material is arranged in, may have a constant amount and distribution of susceptor material per length of the article basically independent of the length of the article. In particular, such final articles may be manufactured having a constant amount and distribution of aerosol-forming gel per length of the article basically independent of the length of the article.

Preferably, a depth of a depression in the susceptor material is between 0.5 millimeter and 2.5 millimeter, more preferably between 1 millimeter and 2 millimeter, for example 1.5 millimeter. The depth of depressions may be kept constant or may vary along the length of the susceptor material. Preferably, the depths of depressions are kept constant along the length of the susceptor material.

Preferably, a height between a crest and a trough in a susceptor material having a wave shape (top of crest to bottom of trough) is between 0.5 millimeter and 5 millimeter, preferably between 1 millimeter and 3 millimeter, for example 2 millimeter. Preferably, the height between crests and troughs is constant along the length of the susceptor material.

Preferably, a width of the susceptor sheet material is larger than a depth of a depression, in particular larger than the height between crest and trough for a susceptor sheet material in wave form.

Preferably, the susceptor sheet material used in the method of the invention or provided in a dosing system or a dosing device is a continuous susceptor sheet material.

Preferably, a final length of the susceptor sheet material corresponds to a length of a plug the susceptor sheet material is arranged in. In some embodiments the final length of the susceptor sheet material may be shorter than the length of a plug the susceptor sheet material is arranged in.

Preferably, the susceptor sheet material is arranged centrally in a plug, preferably in an aerosol-forming substrate plug, for example a tobacco plug. Arranged ‘centrally’ is understood to comprise and be arranged along the longitudinal axis of the plug.

The susceptor sheet material comprising the aerosol-forming gel may be arranged in a plug comprising or being made of aerosol-forming substrate. The susceptor sheet material comprising the aerosol-forming gel may also be arranged in a plug comprising or being made of non-aerosol-forming substrate.

In particular, if the susceptor sheet material comprises aerosol-forming gel in an amount to form sufficient aerosol for a desired application, then the plug the susceptor sheet material is arranged in may be made of a non-aerosol-forming plug material. Such a non-aerosol-forming plug material may, for example, be an aerosol-cooling material, a filter material or an aerosol-directing material. For example such materials may be paper, polylactic acid (PLA) or cellulose acetate tow.

The susceptor sheet material comprising depressions enlarges the surface area and the amount of susceptor material per plug length. Thus, a larger amount of heat may be brought into the plug compared to flat rectangular heater blades. Additionally, more material may be released at a specific temperature. Or, the same amount of material may be released at lower temperatures. Preferably, material released from the aerosol-forming gel is added to material released from the plug. The direct contact of aerosol-forming gel with the susceptor sheet material may release material at a very beginning of the heating of the susceptor sheet material. As soon as the material release from the material of the plug has started, heat may be reduced such that an even and continuous aerosol-delivery profile may be achieved throughout the heating of the susceptor sheet material.

The ‘aerosol-forming gel’ is herein understood to be a material or mixture of materials capable of releasing volatile compounds into an air stream passing through an article the susceptor is arranged in, preferably when the gel is heated. The provision of a gel may be advantageous for storage and transport, or during use, as the risk of leakage from the susceptor, aerosol generating article or aerosol generating device, may be reduced.

Advantageously the gel is solid at room temperature. ‘Solid’ in this context means that the gel has a stable size and shape and does not flow. Room temperature in this context means 25 degrees Celsius.

The gel may comprise an aerosol-former. Ideally the aerosol-former is substantially resistant to thermal degradation at the operating temperature of the susceptor. Suitable aerosol-formers are well known in the art and include, but are not limited to: polyhydric alcohols, such as triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Polyhydric alcohols or mixtures thereof, may be one or more of triethylene glycol, 1, 3-butanediol and, glycerine or polyethylene glycol.

Advantageously, the gel, for example, comprises a thermoreversible gel. This means that the gel will become fluid when heated to a melting temperature and will set into a gel again at a gelation temperature. The gelation temperature may be at or above room temperature and atmospheric pressure. Atmospheric pressure means a pressure of 1 atmosphere. The melting temperature may be higher than the gelation temperature. The melting temperature of the gel may be above 50 degrees Celsius, or 60 degrees Celsius or 70 degrees Celsius and may be above 80 degrees Celsius. The melting temperature in this context means the temperature at which the gel is no longer solid and begins to flow.

Alternatively, in specific embodiments, the gel is a non-melting gel that does not melt during use of the susceptor. In these embodiments, the gel may release the active agent at least partially at a temperature that is at or above the operation temperature of the susceptor in use, but below the melting temperature of the gel.

Preferably, the gel has a viscosity of 50,000 to 10 Pascal per second, preferably 10,000 to 1,000 Pascal per second to give the desired viscosity.

In combination with specific embodiments the gel comprises a gelling agent. In specific embodiments the gel comprises agar or agarose or sodium alginate or Gellan gum, or a mixture thereof.

In specific embodiments the gel comprises water, for example, the gel is a hydrogel. Alternatively, in specific embodiments the gel is non-aqueous.

Preferably the gel comprises an active agent. In combination with specific embodiments the active agent comprises nicotine (for example, in a powdered form or in a liquid form) or a tobacco product or another target compound for, for example, release in an aerosol. In specific embodiments the nicotine is included in the gel with an aerosol-former. Locking the nicotine into a gel at room temperature is desirable to prevent leakage of the nicotine from an aerosol-generating article.

In specific embodiments the gel comprises a solid tobacco material that releases flavour compounds when heated. Depending on the specific embodiments the solid tobacco material is, for example, one or more of: powder, granules, pellets, shreds, spaghettis, strips or sheets containing one or more of: plant material, such as herb leaf, tobacco leaf, fragments of tobacco ribs, reconstituted tobacco, homogenised tobacco, extruded tobacco and expanded tobacco.

There are embodiments where the gel comprises other flavours, for example menthol. Menthol can be added either in water or in the aerosol former prior to the formation of the gel.

In embodiments where agar is used as the gelling agent, the gel may comprise between 0.5 and 5 percent by weight, preferably between 0.8 and 1 percent by weight, agar. Preferably the gel further comprises between 0.1 and 2 percent by weight nicotine. Preferably, the gel further comprises between 30 percent and 90 percent by weight (or between 70 and 90 percent by weight) glycerine. In specific embodiments a remainder of the gel comprises water and flavourings.

Preferably the gelling agent is agar, which has the property of melting at temperatures above 85 degrees Celsius and turning back to gel at around 40 degrees Celsius. This property makes it suitable for hot environments. The gel will not melt at 50 degrees Celsius, which is useful if the system is left in a hot automobile in the sun, for example. A phase transition to liquid at around 85 degrees Celsius means that the gel only needs to be heated to a relatively low-temperature to induce aerosolization, allowing low energy consumption. It may be beneficial to use only agarose, which is one of the components of agar, instead of agar.

When Gellan gum is used as the gelling agent, typically the gel comprises between 0.5 and 5 percent by weight Gellan gum. Preferably the gel further comprises between 0.1 and 2 percent by weight nicotine. Preferably, the gel comprises between 30 percent and 99.4 percent by weight gylcerin. In specific embodiments a remainder of the gel comprises water and flavourings.

In one example, the gel comprises 2 percent by weight nicotine, 70 percent by weight glycerol, 27 percent by weight water and 1 percent by weight agar.

In another example, the gel comprises 65 percent by weight glycerol, 20 percent by weight water, 14.3 percent by weight tobacco and 0.7 percent by weight agar.

Below there is provided a non-exhaustive list of non-limiting examples. Any one or more of the features of these examples may be combined with any one or more features of another example, embodiment, or aspect described herein.

Example Ex1: A method for the manufacture of a susceptor sheet material comprising an aerosol-forming gel, the method comprising:

providing a susceptor sheet material comprising at least one depression;

applying an aerosol-forming gel to at least the depression in the susceptor sheet material.

Example Ex2: The method according to example Ex 1, further comprising

providing the susceptor sheet material with at least one depression on both sides of the susceptor sheet material, and

applying aerosol-forming gel to the at least one depression on both sides of the susceptor sheet material.

Example Ex 3: The method according to any one of the preceding examples, further comprising applying different aerosol-forming gels to different depressions of the susceptor sheet material, wherein different aerosol-forming gels differ in at least one of flavour, nicotine, aerosol-forming agent, aerosolization temperature.

Example Ex4: The method according to any one of the preceding claims, therein applying the aerosol-forming gel via a through hole in at least one moving tooth of a gel dosing device.

Example Ex5: The method according to example Ex4, therein applying the aerosol-forming gel via the through hole in at least one moving tooth of a dosing wheel drum comprising circumferentially arranged teeth.

Example Ex6: The method according to example Ex4, therein applying the aerosol-forming gel via the through hole in at least one moving tooth of a dosing belt, and transporting the susceptor sheet material with the dosing belt.

Example Ex7: The method according to any one of the preceding examples, therein applying the aerosol-forming gel over a width of the susceptor sheet material through a plurality of through holes arranged over a width of the tooth.

Example Ex8: The method according to example Ex4, therein applying the aerosol-forming gel via the through hole in at least one moving tooth of a dosing roller.

Example Ex9: The method according to example Ex8, wherein the at least one moving tooth of the dosing roller is arranged parallel to the direction of transport of the susceptor sheet material.

Example Ex10: The method according to any one of example Ex1 to Ex3, comprising:

providing a conduit with at least one gel inlet,
guiding the susceptor sheet material inside and along the conduit,
injecting aerosol-forming gel via the at least one gel inlet into the conduit and to the susceptor sheet material guided inside and along the conduit.

Example Ex11: The method according to any one of the preceding examples, comprising:

forming the susceptor sheet material to comprise the at least one depression by passing the susceptor sheet material through a susceptor forming device.

Example Ex12: The method according to example Ex11, comprising forming the at least one depression in the susceptor sheet material by passing the susceptor sheet material in between a pair of engaging toothed wheel drums.

Example Ex13: The method according to example Ex11, comprising forming the at least one depression in the susceptor sheet material by passing the susceptor sheet material below a forming roller, wherein the forming roller comprises a circumferentially arranged tooth extending in rotation direction of the forming roller.

Example Ex14: The method according to any one of the preceding examples, further comprising passing the susceptor sheet material and a porous sheet material in parallel through a gel dosing device, thereby applying the aerosol-forming gel to the combination of susceptor sheet material and porous sheet material.

Example Ex15: A dosing system for the application of an aerosol-forming gel to a susceptor sheet material, the system comprising

a susceptor sheet material comprising at least one depression;
a gel dosing device adapted to apply aerosol-forming gel to the at least one depression of the susceptor sheet material.

Example Ex16: The dosing system according to example Ex11, wherein the gel dosing device comprises a dosing wheel drum comprising circumferentially arranged teeth substantially corresponding to the form of the susceptor sheet material, wherein at least one tooth of the dosing wheel drum comprises the through hole in fluid communication with the gel reservoir, preferably the gel dosing device comprises a pair of engaging dosing wheel drums, wherein at least one tooth of both dosing wheel drums of the pair of dosing wheel drums comprises a through hole in fluid communication with a gel reservoir.

Example Ex17: The dosing system according to Ex15, comprising a susceptor sheet material comprising at least one depression on both sides of the susceptor sheet material;

a gel dosing device adapted to apply aerosol-forming gel to the at least one depression on both sides of the susceptor sheet material.

Example Ex18: A dosing system according to example Ex17, wherein the gel dosing device comprises a pair of engaging dosing wheel drums comprising circumferentially arranged teeth substantially corresponding to the form of the susceptor sheet material, wherein at least one tooth of both dosing wheel drums of the pair of dosing wheel drums comprises a through hole in fluid communication with a gel reservoir.

Example Ex19: The dosing system according to example Ex15, wherein the gel dosing device comprises a dosing belt for transporting the susceptor sheet material, and the tooth is a tooth of the dosing belt, preferably the dosing belt comprises a series of teeth substantially corresponding to the form of the susceptor sheet material, each tooth of the series of teeth comprising a through hole.

Example Ex20: The dosing system according to example E15, wherein the gel dosing device comprises a dosing roller comprising at least one circumferentially arranged tooth,

wherein the at least one circumferentially arranged tooth extends in rotation direction of the dosing roller, and wherein the at least one tooth of the dosing roller comprises the through hole in fluid communication with the gel reservoir, preferably the gel dosing device comprises a pair of engaging dosing rollers, wherein at least one tooth of both dosing rollers of the pair of dosing rollers comprises a through hole in fluid communication with a gel reservoir.

Example Ex21: The dosing system according to any one of examples Ex15 to Ex19, wherein the at least one depression is an elongate depression extending perpendicular to the transport direction of the susceptor sheet material.

Example Ex22: The dosing system according to any one of examples Ex15 to Ex20, wherein the at least one depression is an elongate depression extending parallel to the transport direction of the susceptor sheet material.

Example Ex23: The dosing system according to example Ex15, wherein the gel dosing device comprises a conduit adapted to guide the susceptor sheet material inside and along the conduit, the conduit comprising at least one gel inlet for injection of aerosol-forming gel into the conduit and to the susceptor sheet material guided inside and along the conduit.

Example Ex24: The dosing system according to example Ex23, wherein the conduit comprises two gel inlets arranged opposite each other at the conduit.

Example Ex25: A susceptor sheet material comprising aerosol-forming gel, the susceptor sheet material comprising a plurality of depressions, wherein at least one depression of the plurality of depressions in the susceptor sheet material is filled with the aerosol-forming gel.

Example Ex26: The susceptor sheet material according to example Ex25 comprising a plurality of depressions arranged on both sides of the susceptor sheet material, wherein at least one depression of the plurality of depressions on both sides in the susceptor sheet material is filled with the aerosol-forming gel.

Example Ex27: The susceptor sheet material according to any one of examples Ex25 to Ex26, wherein at least some of the depressions of the plurality of depressions are elongate depressions, extending along a length or a width of the susceptor sheet material.

The invention is further described with regard to embodiments, which are illustrated by means of the following drawings, wherein:

FIG. 1: shows a susceptor band with triangular wave shape;

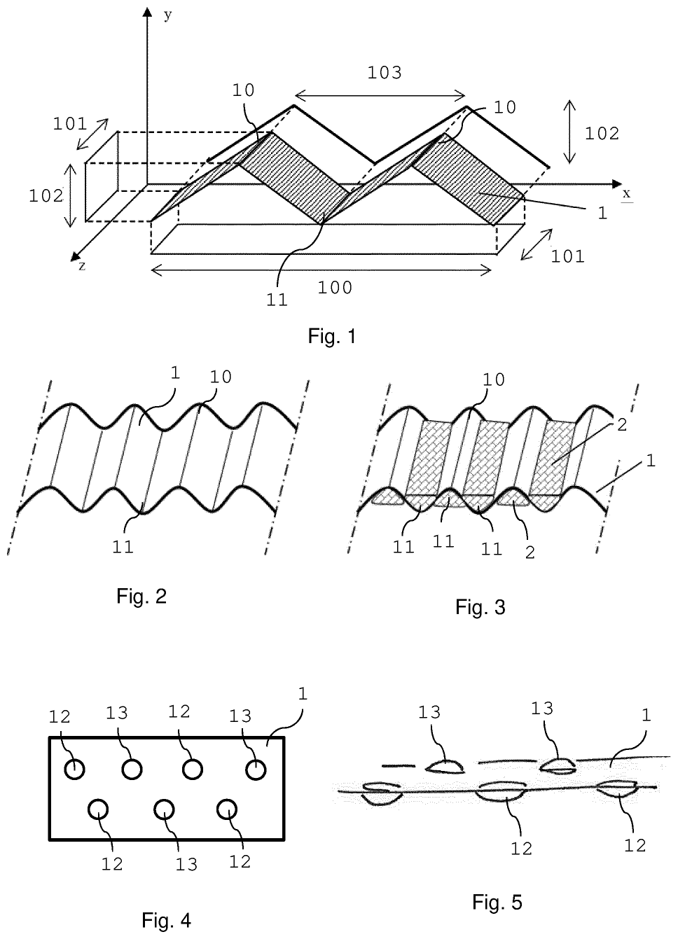

FIG. 2: shows a susceptor band with sinusoidal shape;

FIG. 3: shows the susceptor of FIG. 2 with gel in troughs;

FIG. 4: shows a top or bottom view of a susceptor band with depressions in the form of protrusions and indentations;

FIG. 5: shows a perspective view of another susceptor band with depressions in the form of protrusions and indentations;

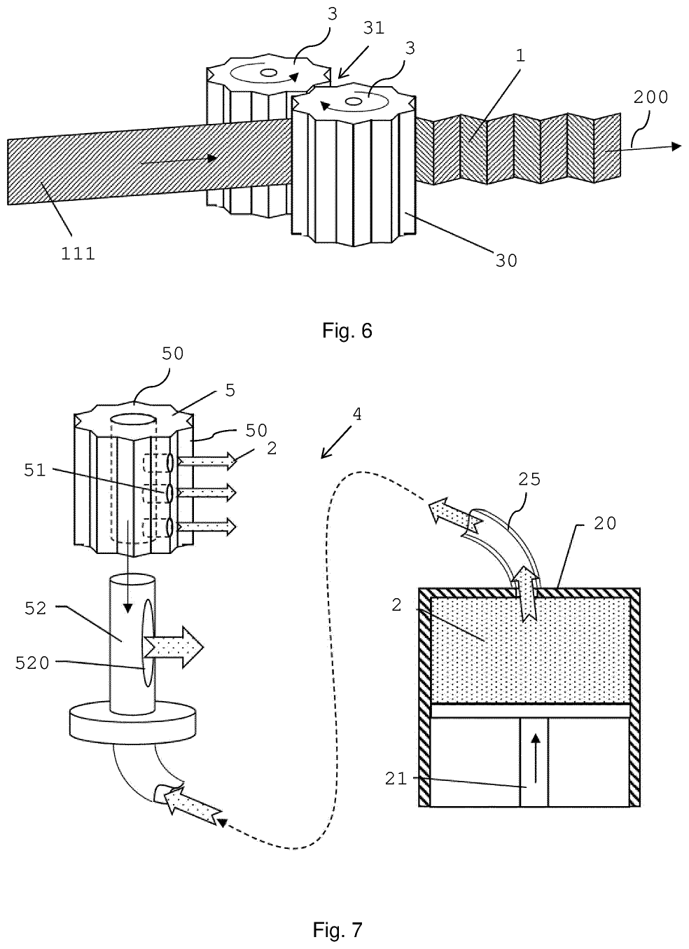

FIG. 6: is a perspective view of a forming device;

FIG. 7: is a schematic view of a dosing system;

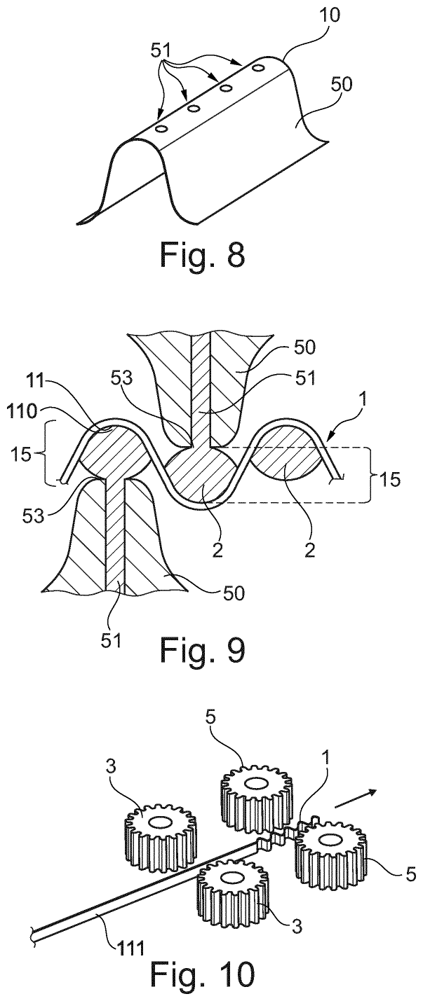

FIG. 8: shows a detail of a dosing system;

FIG. 9: is a schematic view of gel application;

FIG. 10: shows a schematic view of a sequence with a forming device and a dosing device;

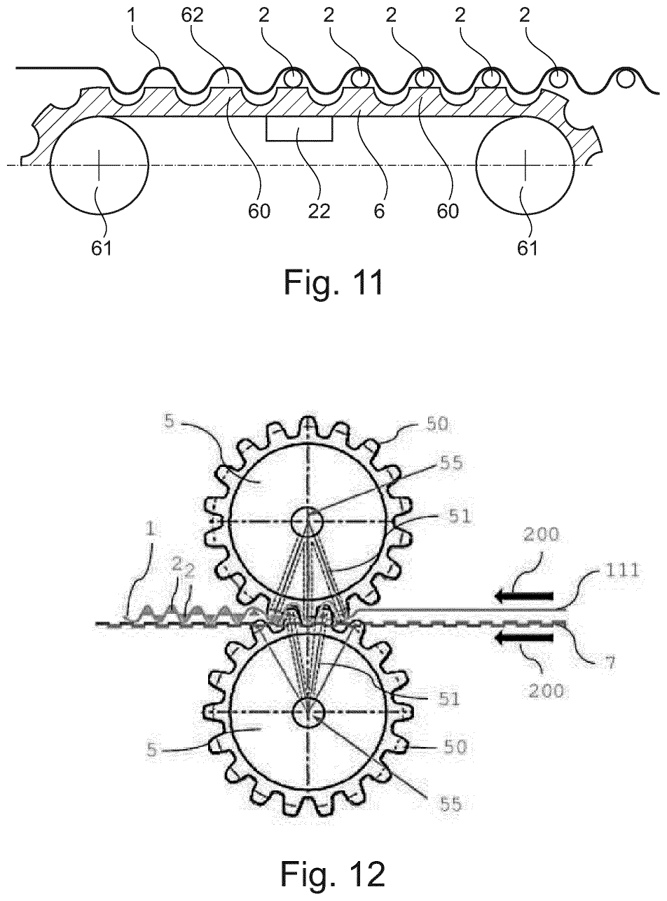

FIG. 11: shows a side cut view of a dosing belt;

FIG. 12: is a schematic view of a combined forming and dosing device with porous sheet material;

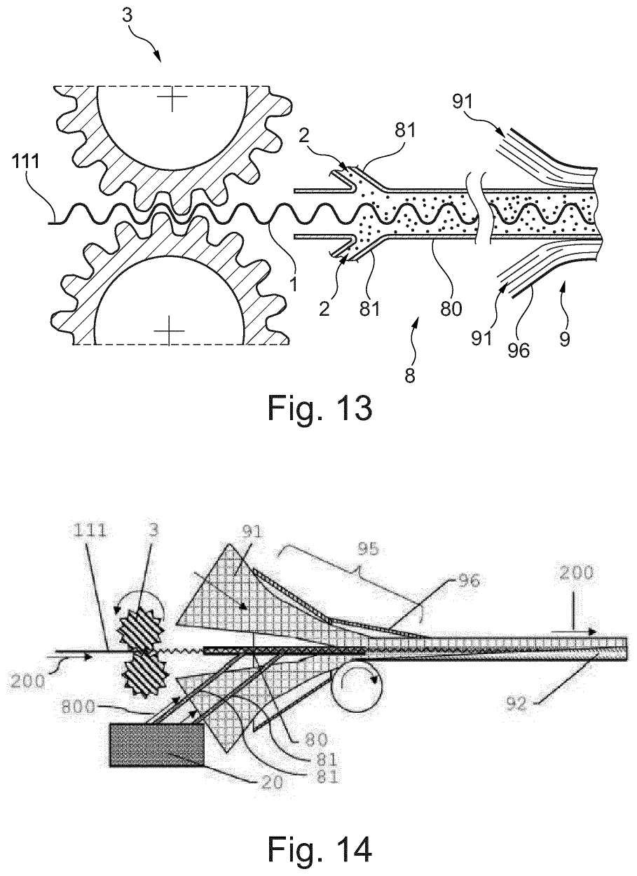

FIG. 13: is a schematic view of a sequentially arranged forming device and dosing device with subsequent rod forming;

FIG. 14: shows a forming and subsequent dosing system integrated in rod forming device;

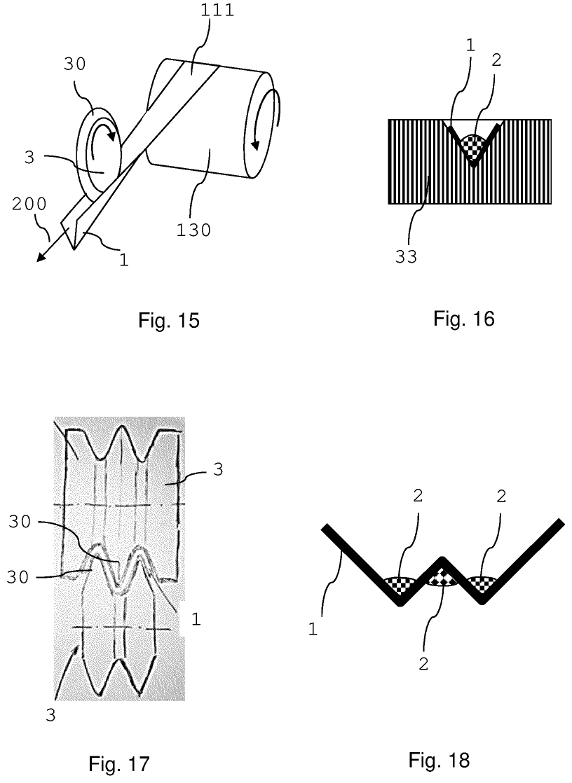

FIG. 15: shows a forming device for a longitudinally grooved susceptor material;

FIG. 16: is a cross-sectional view of a v-shaped susceptor material filled with gel;

FIG. 17: is a schematic view of a forming device for a w-shaped susceptor;

FIG. 18: shows a w-shaped susceptor filled with gel on both sides of the susceptor.

FIG. 1 shows a susceptor sheet material 1 in the form of a wave having zig-zag form. The crests 10 and troughs 11 are v-shaped and form a regular wave along the length 100 of the susceptor. The troughs 11 form depressions for application of aerosol-forming gel. A crest 10 on one side of the susceptor 1 forms a trough 11 on the opposite side of the susceptor and accordingly a trough on the opposite side of the susceptor. The wave crests 10 and troughs 11 are arranged perpendicular to the length of the susceptor band 1.

A height 102 of the susceptor 1 is preferably a range between 0.5 mm and 5 mm.

A width 101 of the susceptor 1 is preferably a range between 2 mm and 8 mm.

A distance 103 between neighbouring crests 10 or between neighbouring troughs 11 are, for example, in a range between 1 mm and 10 mm.

FIG. 2 shows a susceptor sheet material 1 having a sinusoidal wave form. The crests 10 and troughs 11 have a rounded form and are u-shaped. The susceptor forms a regular wave along the length of the susceptor.

Height, width and distance between crests 10 and troughs 11 is preferably in a same range as for the susceptor sheet material 1 shown and described in FIG. 1.

FIG. 3 shows the susceptor 1 of FIG. 2 provided with aerosol-forming gel 2. The gel 2 is arranged in all troughs 11 of the susceptor 1 and over the width of the susceptor 1. The gel 2 is arranged in all troughs 11 on both sides of the susceptor 1. The gel 2 may be the same on both sides of the susceptor 1. The gel 2 may be different on the two sides of the susceptor 1.

FIG. 4 shows an embodiment of a susceptor sheet 1 with two parallel rows of confined depressions arranged along the length of the susceptor band 1. The depressions may be protrusions 13 and indentations 12 when seen from a top view of the susceptor. Protrusions 13 and indentations 12 are arranged in an alternate manner along a row.

In the embodiment shown in FIG. 5, the confined depressions are also arranged in two parallel rows along the length of the susceptor band 1. However, one row is formed by protrusions 13 and the second row is formed by indentations 12. All or only some of the indentations 12 and protrusions 13 may be filled with aerosol-forming gel.

FIG. 6 shows a forming device comprising two forming rollers 3. The forming rollers 3 comprise circumferentially arranged teeth 30 engaging each other in a forming section 31 of the forming device.

A flat susceptor band 111 is transported along the transport direction 200 and is made to pass between the two forming rollers 3. The engaging teeth 30 form the susceptor band while the band passes between the forming rollers 3. The flat susceptor band 11 is formed into a susceptor band having a wave form 1 according to the form of the teeth of the rollers 3. By the form of the teeth 30 as well as a distance of the rollers 3, the wave form of the susceptor may be defined.

FIG. 7 shows as gel dosing device 4 comprising a dosing wheel drum 5. The dosing wheel drum 5 comprises circumferentially arranged teeth 50. One of the teeth comprises three through holes 51 for gel 2 application. The through holes 51 extend from the tip of the tooth 50 to a centrally arranged shaft 52 (shown in explosion view). The shaft 52 is provided with a shaft opening 520 to be brought in fluid communication with the through holes 51. The shaft 52 is connected to a gel reservoir via a gel line 25. The gel reservoir 20, for example a gel tank, is provided with a pump 21. By the pump 21 the gel 2 may be pumped from the gel reservoir 20 through the gel line 25 to the shaft 52 of the dosing wheel drum 5. The gel 2 is then pressed through the shaft opening 520 and the through holes 51 out of the tooth of the wheel drum 5.

The dosing wheel drum 5 is mounted on the shaft 52 and may rotate around the shaft 52. Thus, only when the through holes 51 are concurrently arranged with the shaft opening 52, gel is provided through the through holes 51 and may be applied to one or several depressions in a susceptor material. Preferably, the arrangement of shaft opening 52 with through holes 51 is correlated with the position of the tooth 50 being arranged close to a depression or in a depression of a susceptor sheet material.

Through holes may also be provided in other teeth 50 of the dosing wheel drum 5.

FIG. 8 schematically shows an individual tooth 50 of a gel dosing device, for example of a dosing wheel drum as shown in FIG. 7. The tooth 50 has a rounded crest 10. Four through holes 51 are arranged equidistantly over the width of the tooth.

In FIG. 9 gel 2 application to two sides of a susceptor sheet material 1 in wave form is shown.

Two teeth 50 of two gel dosing devices are shown. One tooth 50 of the one dosing device is arranged above the susceptor 1 and the other tooth 50 of the second dosing device is arranged below the susceptor 1. Each tooth comprises a through hole 51 in fluid connection with a gel reservoir (not shown).

For gel application, the tips 53 of the teeth 50 are not in contact with the susceptor 1 but are distanced by a distance 15 from the bottom 110 of the troughs 11 of the susceptor 1. The distance 15 leaves space for the gel 2 applied to the troughs 11 such that the gel 2 remains in the troughs basically as applied, and is in particular not forced out of the troughs.

The teeth 50 may, for example, be teeth of a dosing wheel drum 5 as described in FIG. 7 or may be teeth of a dosing belt as will be described further below.

FIG. 10 is a schematic drawing of a combination of a forming device with a subsequently arranged dosing device. The forming device comprising two toothed forming rollers 3 has already been described relating to FIG. 6. The flat susceptor band 111 is deformed by the forming device and is provided with a wave shape. The wave-shaped susceptor 1 is then guided between two toothed dosing wheel drums 5. Preferably, the teeth of the dosing wheel drums 5 have an identical form and size as the teeth of the forming rollers 5. At least one tooth of each of the dosing wheel drums 5 comprises one or several through holes for application of gel to both sides of the susceptor. A dosing wheel drum 5 including gel supply may, for example, be realized as shown and described in FIG. 7.

Forming device and dosing device can be combined as forming and dosing device. Therein, the engaging teeth of the dosing wheel drums acts as forming and dosing teeth (see also FIG. 11 below).

In FIG. 11 a dosing device comprising a dosing belt 6 is shown. The dosing belt 6 may be an endless belt guided around transport rollers 61.

The dosing belt comprises a continuous series of teeth 60. The distances between the teeth 60 of the dosing belt 6 correspond to the distance between wave troughs of the susceptor 1 in wave form. By this, the susceptor 1 is transported by the dosing belt 6 while being provided with gel 2. The teeth 60, preferably all teeth of the dosing belt 6 are provided with a through hole (not shown). The through hole extends from the tip 62 of a tooth 60 to the gel dispenser 22 arranged below the dosing belt 6. When the dosing belt passes the gel reservoir 22, that tooth of the dosing belt being arranged above the gel reservoir 22 is provided with gel. The gel 2 is applied to a trough on the underside of the susceptor 1. The teeth 60 of the dosing belt 6 have a flat tip 62. A space is formed between the flat tip 62 and the bottom of the trough of the susceptor 1 for the gel 2.

FIG. 12 shows a combined forming and dosing device. The combined forming and dosing device comprises two toothed wheel drums 5. Both dosing wheel drums 5 rotate about a center 55, where gel 2 is provided. The drums further comprise through holes 51 from the center 55 to tips of the teeth 50 of the drums. In FIG. 12, three through holes 51 of the upper wheel drum are provided with gel 2, two through holes 51 of the lower wheel drum 5 are provided with gel 2. The teeth 50 provided with gel are in contact with the susceptor 111 forming the susceptor and at the same time providing gel into the formed troughs on both sides of the susceptor 1.

A flat susceptor band 111 and a porous sheet material 7, for example made of cotton or viscose, is arranged above each other and guided together to the dosing and forming device. The two sheets 111, 7 are made to pass in between the two dosing wheel drums 5. Thereby, susceptor sheet 111 is provided with a wave form according to the engaging teeth 50 of the two wheel drums 5. The porous material 7 is arranged parallel to the susceptor 1 and may help to fix the gel in its position relative to the susceptor 1. The porosity of the porous material may allow at least a portion of the gel to pass through the porous material.

In FIG. 13 a forming device with engaging forming rollers 3, for example as described in FIG. 6, is arranged in line with a dosing device 8. The dosing device 8 comprises a conduit in the form of a tube 80, for example of rectangular or circular cross-sectional shape. The susceptor 1 previously provided with a wave form is guided and passes inside and along the tube 80 in transport direction 200. The tube comprises two gel inlets 81. The gel inlets 81 are arranged opposite each other on an upper side and on a lower side of the tube 80 at substantially the same position along the transport path of the susceptor 1. Aerosol-forming gel 2 is supplied to the two gel inlets 81 and applied to a top side of the susceptor 1 and to a bottom side of the susceptor 1 while the susceptor 1 moves inside the tube 80.

The tube 80 is arranged in an inlet section of a funnel portion 95 of a rod making device 9. The tube 80 extends into the tongue part 96 of the funnel portion 95 of the rod making device 9. As may be seen in more detail in FIG. 14, a sensorial media 91, for example tobacco material such as a homogenized tobacco sheet, is guided into the funnel portion and is compressed therein. The so formed rod with the susceptor 1 provided with aerosol-forming gel 2 in the center of the rod and surrounded with sensorial media 91, is then wrapped with a wrapper 92, for example wrapping paper.

As the susceptor 1 is provided with aerosol-forming gel 2, the sensorial media 91 may comprise or be replaced by a hosting media for hosting the susceptor. A hosting media does not have to be or comprise an aerosol-forming material used for aerosol formation.

In FIG. 14, the dosing device also comprises two gel inlets 81. The two gel inlets 81 are arranged in series along the tube 80, on a bottom side of the tube 80. The first one of the two gel inlets 81 may be used for a partial filling of the troughs in the susceptor. The second gel inlet 81 arranged downstream of the first gel inlet 81 may be used for a complete filling of the troughs. Depending on a transport speed of the susceptor 1 through the dosing device and a gel supply, an amount of gel applied to the susceptor may be defined.

In FIG. 14 the two gel inlets 81 are connected to a gel reservoir 20. The gel reservoir may be filled with a same aerosol-forming gel or may comprise separate tank compartments filled with two different gels. The two gel inlets 81 are then preferably connected to the separate tank compartments. By this, different gel, for example having different material composition, may be applied to the susceptor 1 at same or different positions along the susceptor 1.

FIG. 15 and FIG. 16 show parts of a forming device for a susceptor material 1. The susceptor material is provided in the form of a flat band 111 from a bobbin 130.

The band 111 is transported along the transport direction 200 and is made to pass under a forming roller 3 and preferably between the forming roller 3 shown in FIG. 15 and a lower mould 33 shown in FIG. 16. The lower mould 33 may be a stationary female mould or may be part of another rotating forming roller.

The forming roller 3 has the form of a disc and comprises a circumferentially running tooth 30. The disc 3 is arranged parallel to the length of the susceptor 1 and the forming roller 3 rotates counter to the transport direction 200 of the susceptor material.

The engaging circumferentially running tooth 30 of the forming roller 3 and the v-shaped groove in the lower mould 33 form the susceptor band 111 while the band passes between the forming roller 3 and the lower mould 33. A susceptor band with a longitudinally running groove is formed. The susceptor has a cross section in the shape of the letter ‘v’. The groove forms a longitudinally running depression that is filled with aerosol-forming gel. The gel may be provided continuously or in sections along the groove.

A dosing device for filling the depression in such a v-shaped susceptor may, for example, be a dosing roller. The set-up and working principle of a dosing wheel drum has been described with respect to FIG. 7. However, a dosing roller for dosing an amount of aerosol-forming gel into a longitudinally running groove in the susceptor comprises a circumferentially running tooth, which is arranged parallel to the groove in the susceptor material.

It is understood that the forming device of FIG. 15 may be combined as forming and dosing device.

FIG. 17 shows a forming device for the manufacture of a susceptor material 1 comprising a cross-section in the shape of the letter ‘w’, shown in more detail in FIG. 18.

Two forming rollers 3 are provided. One of the rollers 3 has one circumferentially running tooth 30 and the second roller 3 has two circumferentially running teeth 30. The teeth are formed by the circumference of the discs arranged in parallel to each other along the length of a forming roller 3.

The engaging teeth 30 of the two forming rollers 3 form the susceptor band while the band passes between the forming rollers 3. A flat susceptor band 111 is formed into a susceptor band having a w-shaped cross section according to the form of the teeth 30 of the rollers 3. Two longitudinally running grooves are formed on one side of the susceptor 1 representing two depressions and one longitudinally running groove is formed on the opposite side of the susceptor 1 representing one depression.

In the example of FIG. 18, the depressions on the one side of the susceptor 1 are filled with one kind of gel 2 and the depression on the opposite side of the susceptor 1 is filled with a different kind of gel 2.

Also in the examples where depressions extend along the length of a susceptor, a groove forms a depression for application of aerosol-forming gel. A groove on one side of the susceptor 1 forms a crest on the opposite side of the susceptor. The grooves and crests are arranged parallel to the length of the susceptor band 1.

As may well be seen from the examples described and shown in the application, susceptor sheet material having different forms of depressions may be combined with different dosing devices. For example, basically any form of susceptor sheet material provided with depressions may be supplied to a conduit of a gel dosing device for gel application according to FIGS. 13 and 14.

While dosing wheel drums and dosing belts have mainly been described in combination with susceptor sheet material having a wave form or elongate depressions extending perpendicular to a transport direction of the susceptor sheet material, dosing wheel drums and dosing belts may also be used for application of gel into a longitudinally arranged groove in a susceptor sheet material. A dosing wheel drum could, for example, be provided as disc-shaped wheel comprising circumferentially arranged teeth, where one, several or all teeth are intended for gel application, and wherein the teeth may provide individual dots of gel into the groove along the length of the susceptor. Alternatively, the dosing wheel drum could be provided with a row of circumferentially arranged teeth, to provide gel to a series of grooves arranged parallel in the susceptor sheet material or to a groove each of a separate susceptor sheet material arranged parallel to each other.

1. Method for the manufacture of a susceptor sheet material comprising an aerosol-forming gel, the method comprising:
providing a susceptor sheet material comprising at least one depression on both sides of the susceptor sheet material;
applying aerosol-forming gel to the at least one depression on both sides of the susceptor sheet material.

2. Method according to claim 1, further comprising applying different aerosol-forming gels to different depressions of the susceptor sheet material, wherein different aerosol-forming gels differ in at least one of flavour, nicotine, aerosol-forming agent, aerosolization temperature.

3. Method according to claim 1, therein applying the aerosol-forming gel via a through hole in at least one moving tooth of a gel dosing device.

4. Method according to claim 3, therein applying the aerosol-forming gel via the through hole in at least one moving tooth of a dosing wheel drum comprising circumferentially arranged teeth.

5. Method according to claim 3, therein applying the aerosol-forming gel via the through hole in at least one moving tooth of a dosing belt, and transporting the susceptor sheet material with the dosing belt.

6. Method according to claim 1, therein applying the aerosol-forming gel over a width of the susceptor sheet material through a plurality of through holes arranged over a width of the tooth.

7. Method according to claim 1, comprising:
providing a conduit with at least one gel inlet,
guiding the susceptor sheet material inside and along the conduit,
injecting aerosol-forming gel via the at least one gel inlet into the conduit and to the susceptor sheet material guided inside and along the conduit.

8. Method according to claim 1, comprising:
forming the susceptor sheet material to comprise the at least one depression by passing the susceptor sheet material through a susceptor forming device.

9. Method according to claim 1, further comprising passing the susceptor sheet material and a porous sheet material in parallel through a gel dosing device, thereby applying the aerosol-forming gel to the combination of susceptor sheet material and porous sheet material.

10. Dosing system for the application of an aerosol-forming gel to a susceptor sheet material, the system comprising
a susceptor sheet material comprising at least one depression on both sides of the susceptor sheet material;
a gel dosing device adapted to apply aerosol-forming gel to the at least one depression on both sides of the susceptor sheet material.

11. Dosing system according to claim 10, wherein the gel dosing device comprises a pair of engaging dosing wheel drums comprising circumferentially arranged teeth substantially corresponding to the form of the susceptor sheet material, wherein at least one tooth of both dosing wheel drums of the pair of dosing wheel drums comprises a through hole in fluid communication with a gel reservoir.

12. Dosing system according to claim 10, wherein the gel dosing device comprises a dosing belt for transporting the susceptor sheet material, and the tooth is a tooth of the dosing belt, preferably the dosing belt comprises a series of teeth substantially corresponding to the form of the susceptor sheet material, each tooth of the series of teeth comprising a through hole.

13. Dosing system according to claim 10, wherein the gel dosing device comprises a conduit adapted to guide the susceptor sheet material inside and along the conduit, the conduit comprising at least one gel inlet for injection of aerosol-forming gel into the conduit and to the susceptor sheet material guided inside and along the conduit.

14. Dosing system according to claim 13, wherein the conduit comprises two gel inlets arranged opposite each other at the conduit.

15. Susceptor sheet material comprising aerosol-forming gel, the susceptor sheet material comprising a plurality of depressions arranged on both sides of the susceptor sheet material, wherein at least one depression of the plurality of depressions on both sides in the susceptor sheet material is filled with the aerosol-forming gel.

16. Method according to claim 2, comprising:
providing a conduit with at least one gel inlet,
guiding the susceptor sheet material inside and along the conduit,
injecting aerosol-forming gel via the at least one gel inlet into the conduit and to the susceptor sheet material guided inside and along the conduit.
